(19) United States
(12) Patent Application Publication
(10) Pub. No.: US 2014/0279669 A1
(43) Pub. Date: Sep. 18, 2014

(54) Predictive Order Scheduling

(71) Applicant: Arno Diego Bruns, Walzbachtal (DE)

(72) Inventor: Arno Diego Bruns, Walzbachtal (DE)

(73) Assignee: SAP AG, Walldorf (DE)

(21) Appl. No.: 13/799,422

(22) Filed: Mar. 13, 2013

(51) Int. Cl. G06Q 10/08

(52) U.S. Cl. CPC G06Q 10/0838
USPC 705/341

(57) ABSTRACT

A method includes receiving an order for materials, analyzing the order to obtain selected order characteristics, executing a query in a database containing a history of orders to find previous orders having similar characteristics, and determining an estimated transit time for the order as function of the previous orders having similar characteristics.

### BACKGROUND

A typical shipper company (manufacturer, retailer, etc.) sells and transports goods to their customers. Such shipper companies are used when a customer orders goods, such as materials to use in manufacturing. The materials may be needed in a timely manner in order to keep production lines operating and meet production goals.

### SUMMARY

A method includes receiving an order for materials, analyzing the order to obtain selected order characteristics, executing a query in a database containing a history of orders to find previous orders having similar characteristics, and determining an estimated transit time for the order as function of the previous orders having similar characteristics.

A computer readable storage device includes instructions to cause a computer to execute a method. The method includes receiving an order for materials, analyzing the order to obtain selected order characteristics, executing a query in a database containing a history of orders to find previous orders having similar characteristics, and determining an estimated transit time for the order as function of the previous orders having similar characteristics.

A system includes a planning and optimizer system adapted to receive an order for materials and analyze the order to obtain selected order characteristics. A transportation and scheduling system generates a query for execution in a database containing a history of orders to find previous orders having similar characteristics. The transportation and scheduling system is adapted to receive an estimated transit time for the order as a function of the previous orders having similar characteristics.

### BRIEF DESCRIPTION OF THE DRAWINGS

FIG. 1 is a block diagram of a system to estimate transit times for materials corresponding to orders according to an example embodiment.

FIG. 2 is a flowchart illustrating a method of determining transit times for orders of material according to an example embodiment.

FIG. 3 is a flowchart illustrating a method of estimating transit times utilizing historical matching orders according to an example embodiment.

FIG. 4 is a block diagram of a computer system for implementing methods and systems according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A typical shipper company (manufacturer, retailer, etc.) sells and transports goods to their customers. Such shipper companies are used when a customer orders goods, such as materials to use in manufacturing. The materials may be needed in a timely manner in order to keep production lines operating and meet production goals. An average sales order quantity for materials typically fills less than a complete truckload (LTL). A shipper desires to make optimal use of a transportation system, and will consolidate orders/loads as much as possible. Shippers consolidate orders/loads, because transporting with a full truckload (FTL) costs the company far less money and usually is also much faster. It was recognized that for an order resulting in a FTL, transit time may average three days, while an order corresponding to LTL would take up to ten days. The LTL may take longer due to hub handling in order to fill further orders in the same truck.

When an individual order is entered in a customer's enterprise resource planning (ERP) system, the order will contain at least the requested material, the requested delivery date and time, and the destination location. Usually the destination is the customer location. Depending on certain settings, a default delivery plant/warehouse is chosen and then a system first performs a backward scheduling based on the estimated transport duration (requested date−transit time) to get a loading date. The settings allow a customer to obtain a needed material availability date which serves as a basis to do a material availability check (is enough stock available?). If the material proves to be available for the load date required, the dates are stored and the order is further processed. If there is no available stock, then the date is shifted to a new material availability date (the actual date when the material will be available) which then triggers a new transportation duration or transit time calculation to return a new delivery date in the future. Variations can happen based on location/material substitution which is described in the documentation to the “global availability check”. The resulting calculated dates are then communicated to the customer as promised dates.

A problem that was recognized is related to the calculation of the transportation duration/transit time. Today's systems (e.g. SAP Transportation Management (TM)) can already take into account the specifics of a transportation network (e.g. locations, schedules, opening hours, vehicle resources, etc.). But such systems do not take into account the order consolidation possibilities at the time of order entry. In some systems, documents are created on the fly for a particular ERP-order (or for a material line item if an ATP check is triggered for just an item) and planned individually. No order consolidation by the shipper is taken into account. In the above example this would lead to a transit time of 10 days. After having planned this single ERP-order, the TM documents are discarded and the dates are returned to the ERP for further processing. As described above, the scheduling is performed in some cases more than just once. After saving the ERP-order in the current embodiment, the corresponding document in the TM will be created. Only after the order is transferred to the TM system the planner can consolidate loads. These are the normal planning activities done today. Here the planner could come up with a FTL and a three day transit time which then would be hopefully communicated to the ERP (not in current TM available) and to the customer. So the customer would get potentially first a wrong promised delivery date. If this TM order scheduling functionality would be extended to directly book into the current overall transportation plan, the consolidation would be taken into account thus giving the correct transit times to the customer. But then the single scheduling call would require a very large amount of time and computing power as multiple orders, resources, locations, etc. would have been taken into account.

A further performance and update problem would occur if the order really undergoes the global availability check with multiple location (=plant) and/or product substitutions.

A system 100 in FIG. 1 takes into account order consolidation by the shipper. Applications 110 running on a computer system that may be a stand-alone customer system, a server based system, or a cloud based system in various embodiments, are interacted with by a user via a user interface 115. The applications may include an enterprise resource planning system (ERP) 120, a planning and optimizer system 125, and a transportation scheduling system 130 in various embodiments.

The applications may be stand-alone system running applications that communicate with each other such as via inter process communication (IPC), or may be integrated into a single system. The applications may be embodied in business objects, which contain methods and data for operating on the methods and embody business processes for a customer, allowing for operation of the business. Further functions performed by the applications include human resource management, financial modules, manufacturing control, and other functions. In one embodiment, information corresponding to the applications may be stored and accessed via a database 135. A conventional relational database may be used in some embodiments, and in further embodiments, the database 135 may be an in memory database, such as SAP Hana, that includes an engine that provides for real time aggregations of data that is stored in random access memory. Database 135 may be cloud-based, remote server based, or may reside on the same system as one or more other systems.

Sales orders may be generated via ERP 120 and communicated to planning and optimizer 125. In some embodiments, planning and optimizer 125 may include an entire suite of supply chain planner applications that increase overall knowledge of the supply chain and provide forecasting, planning and optimization. For example, there are eight application levels within SAP APO (advanced planning and optimization): network design, supply network planning, demand planning, production planning and detailed scheduling, transportation planning and vehicle scheduling, global availability and supply chain collaboration.

Planning and optimizer 125 performs an available to promise (ATP) check based on the material source, dates of availability, and production. Using the example above, an order date with ten days transit time would be communicated to the customer for viewing via the user interface 115. The scheduling of new orders may be decoupled from the actual overall transportation plan. Historic data of fulfilled customer orders may be stored in the database 135, and is used by transportation scheduling system 130 to determine likely transit times. In one embodiment, real-time database queries are used in the transportation scheduling application 130 on already executed freight order/shipments. Pattern matching may be used in some embodiments, comparing information related to similar historical orders based on for example supplier, quantity, how the orders are shipped, when they were shipped, and the corresponding transit times, to find matches and determining a delivery date. Further information may be used for matching. The pattern matching allows learning, and may weight more recent historical orders more heavily than older orders. Very accurate estimated transit times are determined in situations where the shipper company is usually receiving LTL sized customer orders and has regular shipping patterns. In further embodiments, neural network type algorithms may be used to determine likely delivery dates.

On ever-changing destinations (e.g. delivery to construction sites) or the need to firmly book transport capacity at order entry, the transportation scheduling system 130 may be switchable to use prior approaches.

FIG. 2 is a flowchart illustrating a method 200 of determining transit time for a proposed order generated at 210 based on a need for a material. The order is checked at 215. If approved, scheduling is called at 220. The order may include a requested delivery date, identify the material, quantity of material, method of payment, and other details common to purchase orders. Once an order is entered and the scheduling is called at 220 (both first backward or second forward ones), the transportation scheduling system is called where the order would be analyzed for characteristics (e.g. departure plant, destination zone, product, priority of customer, etc.). These characteristics form a pattern, and a query is executed at 225 in database 135 to find real-time historic/previous orders with similar characteristics and their freight orders/shipments. Out of that query the degree of consolidation, loading and transit times, delivery time patterns, usage of vehicles, etc. could be extracted and the scheduling call completed with information regarding an expected transit time for the materials corresponding to the entered purchase order. In one embodiment, the database, or search engine associated with the database may return average shipment costs of those historic orders so that the shipper could take this as an input for pricing of his goods. The purchase order may be modified or changed based on the information provided at 230. Changes may be made based on information regarding prior similar purchase orders for the same material from one or more suppliers. Such changes may include consolidating orders to obtain a full truck load, which may actually reduce shipping times and result in materials being delivered more quickly. If not changed, the order may be sent at 235. If changed at 230, the method may return to check the changed order at 215 and proceed with determining a delivery date for the changed purchase order.

A method 300 of using the historical data to determine a delivery date is illustrated in flowchart form in FIG. 3. The method may be implemented in an in memory database in one example having an engine to utilize data stored in random access storage devices such as semiconductor based memory chips. At 310, the database receives a query based on a purchase order. The query may cause a search of the database at 320 for prior purchase orders having similar characteristics. The characteristics may be thought of as a pattern. At 330, close matching patterns are selected. A close matching pattern may have identical characteristics, such as quantities, supplier, and time to requested delivery date in some embodiments, or may have some characteristics that are the same and others that are within a predetermined range. For instance, in one embodiment, similar patterns may include an identical supplier and shipping location, but the quantity may vary by a predetermined percentage, such as plus or minus 5%. Other characteristics may be similarly varied, and the method 300 may learn and modify the percentages over time.

At 340, the close matching patterns are used to determine a likely transit time. In one embodiment, the transit times of close matching patterns may be averaged to determine the likely transit time. The average may be weighted average in some embodiments, with transit times for newer orders weighted heavier than the transit times of older orders. In still further embodiments, a simple vote between the patterns may be used to determine the likely transit time. Information regarding the likely transit time is returned at 350, and may be used to modify the purchase order prior to actually submitting it.

Over time, the method may improve in estimating the dates and other criteria as more historic orders may be taken into account, allowing the method to determine whether previous estimates were accurate, and modify weighting or change learning algorithm parameters accordingly.

In addition, this approach would have the advantage that often there is a triangle of influence between stock situation, production plan and transportation capabilities. Decoupling transportation planning at order entry allows solving a much less complex delivery problem and provides a good starting point to optimize the shipments later on.

In one example, a shipper A sells 3 different product lines (e.g. frozen, cold+packaged food) P1, P2, P3. To keep the example simple, all products (e.g. P11, P12, P21, etc.) have the same weight volume. In addition, 1000 of any combination of such products make a FTL. Customer B has three stores in one city and each store can order (B1, B2, B3). The stores also have rather regular ordering patterns. Assuming that a FTL has a transit time of three days, and an LTL has a transit time of ten days. Further, the shipper stock situation is satisfactory.

The historic ordering patterns for B1, B2, and B3, in the form of “date:quantity product” are as follows:

### B1—01: 600 P11 02: 600 P13 04: 600 P14

### B2—01: 400 P21 02: 400 P22 05: 600 P27

### B3—03: 500 P34 04: 400 P33 05: 400 P36

Usually transportation planning consolidates the orders received by A in the following manner:

### 01: A-B1-B2 FTL

### 02: A-B1-B2 FTL

### 03: A-B3 LTL

### 04: A-B1-B3 FTL

### 05: A-B2-B3 FTL

Now if an order from B2 on one of the days 01 is 400 P22 instead of P21 then the patterns still have similarities and result in an FTL. If an additional order from B2 comes in for 01 with 100 P23 then a pattern is not found, and the order would be treated like LTL as per default sizing rules. If an order from B3 for a day 03 has a quantity of 600 instead of for 500 then a pattern would be found corresponding to the order being shipped as LTL, resulting in a ten day transit time.

FIG. 4 is a block diagram of a computing device, according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408. Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, a computer program 425 capable of providing a generic technique to perform access control check for data access and/or for doing an operation on one of the servers in a component object model (COM) based system according to the teachings of the present invention may be included on a CD-ROM and loaded from the CD-ROM to a hard drive. The computer-readable instructions allow computer 410 to provide generic access controls in a COM based computer network system having multiple users and servers.

### EXAMPLES

### Example 1

A method comprising

receiving an order for materials;

analyzing the order to obtain selected order characteristics;

executing a query in a database containing a history of orders to find previous orders having similar characteristics; and

determining an estimated transit time for the order as function of the previous orders having similar characteristics.

### Example 2

The method of example 1 and further comprising completing scheduling the order for shipment.

### Example 3

The method of any of examples 1-2 wherein determining an estimated transit time comprises executing an artificial intelligence algorithm.

### Example 4

The method of any of examples 1-3 wherein executing a query to find previous orders having similar characteristics comprises matching patterns of characteristics.

### Example 5

The method of example 4 wherein the database comprises an in memory database.

### Example 6

The method of any of examples 1-5 wherein the similar characteristics comprise material, quantity, and supplier.

### Example 7

The method of example 6 wherein finding previous orders having similar characteristics includes using a threshold for a selected characteristic and determining that a characteristic in a found pattern is similar if it is within the threshold.

### Example 8

The method of example 7 wherein the selected characteristic is a quantity.

### Example 9

The method of example 8 and further comprising providing information corresponding to the previous orders to a user, wherein the information comprises transit times corresponding to previous orders having the same quantity and transit times of previous orders having consolidated quantities to facilitate consolidation of orders to obtain a faster transit time.

### Example 10

The method of example 8 and further comprising:

providing information corresponding to the similar previous orders to a user;

receiving a change to the received order; and

repeating the receiving, analyzing, and executing elements on the changed order.

### Example 11

A computer readable storage device having instructions for causing a computer to perform a method, the method comprising:

receiving an order for materials;

analyzing the order to obtain selected order characteristics;

executing a query in a database containing a history of orders to find previous orders having similar characteristics; and

determining an estimated transit time for the order as function of the previous orders having similar characteristics.

### Example 12

The computer readable storage device of example 11 wherein the method further comprises completing scheduling the order for shipment.

### Example 13

The computer readable storage device of example 12 wherein executing a query to find previous orders having similar characteristics comprises matching patterns of characteristics, wherein the similar characteristics comprise material, quantity, and supplier.

### Example 14

The computer readable storage device of example 13 wherein finding previous orders having similar characteristics includes using a threshold for quantity and determining that a quantity in a found pattern is similar if it is within the threshold.

### Example 15

The computer readable storage device of example 14 wherein the method further comprises providing information corresponding to the previous orders to a user, wherein the information comprises transit times corresponding to previous orders having the same quantity and transit times of previous orders having consolidated quantities to facilitate consolidation of orders to obtain a faster transit time.

### Example 16

The computer readable storage device of any of examples 14-15 wherein the method further comprises:

providing information corresponding to the similar previous orders to a user;

receiving a change to the received order; and

repeating the receiving, analyzing, and executing elements on the changed order.

### Example 17

A system comprising:

a planning and optimizer system adapted to receive an order for materials and analyze the order to obtain selected order characteristics;

a transportation and scheduling system to generate a query for execution in a database containing a history of orders to find previous orders having similar characteristics; and

the transportation and scheduling system adapted to receive an estimated transit time for the order as a function of the previous orders having similar characteristics.

### Example 18

The system of example 17 wherein query is generated to find previous orders having similar characteristics by matching patterns of characteristics via execution in an in memory database, wherein the similar characteristics comprise material, quantity, and supplier.

### Example 19

The system of example 18 wherein finding previous orders having similar characteristics includes using a threshold for quantity and determining that a quantity in a found pattern is similar if it is within the threshold.

### Example 20

The system of example 19 wherein the transportation and scheduling system is further programmed to:

provide information corresponding to the similar previous orders to a user;

receive a change to the received order; and

repeat the receiving, analyzing, and executing elements on the changed order.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving an order for materials;
analyzing the order to obtain selected order characteristics;
executing a query in a database containing a history of orders to find previous orders having similar characteristics; and
determining an estimated transit time for the order as function of the previous orders having similar characteristics.

2. The method of claim 1 and further comprising completing scheduling the order for shipment.

3. The method of claim 1 wherein determining an estimated transit time comprises executing an artificial intelligence algorithm.

4. The method of claim 1 wherein executing a query to find previous orders having similar characteristics comprises matching patterns of characteristics.

5. The method of claim 4 wherein the database comprises an in memory database.

6. The method of claim 1 wherein the similar characteristics comprise material, quantity, and supplier.

7. The method of claim 6 wherein finding previous orders having similar characteristics includes using a threshold for a selected characteristic and determining that a characteristic in a found pattern is similar if it is within the threshold.

8. The method of claim 7 wherein the selected characteristic is a quantity.

9. The method of claim 8 and further comprising providing information corresponding to the previous orders to a user, wherein the information comprises transit times corresponding to previous orders having the same quantity and transit times of previous orders having consolidated quantities to facilitate consolidation of orders to obtain a faster transit time.

10. The method of claim 8 and further comprising:
providing information corresponding to the similar previous orders to a user;
receiving a change to the received order; and
repeating the receiving, analyzing, and executing elements on the changed order.

11. A computer readable storage device having instructions for causing a computer to perform a method, the method comprising:
receiving an order for materials;
analyzing the order to obtain selected order characteristics;
executing a query in a database containing a history of orders to find previous orders having similar characteristics; and
determining an estimated transit time for the order as function of the previous orders having similar characteristics.

12. The computer readable storage device of claim 11 wherein the method further comprises completing scheduling the order for shipment.

13. The computer readable storage device of claim 12 wherein executing a query to find previous orders having similar characteristics comprises matching patterns of characteristics, wherein the similar characteristics comprise material, quantity, and supplier.

14. The computer readable storage device of claim 13 wherein finding previous orders having similar characteristics includes using a threshold for quantity and determining that a quantity in a found pattern is similar if it is within the threshold.

15. The computer readable storage device of claim 14 wherein the method further comprises providing information corresponding to the previous orders to a user, wherein the information comprises transit times corresponding to previous orders having the same quantity and transit times of previous orders having consolidated quantities to facilitate consolidation of orders to obtain a faster transit time.

16. The computer readable storage device of claim 14 wherein the method further comprises:
providing information corresponding to the similar previous orders to a user;
receiving a change to the received order; and
repeating the receiving, analyzing, and executing elements on the changed order.

17. A system comprising:
a planning and optimizer system adapted to receive an order for materials and analyze the order to obtain selected order characteristics;
a transportation and scheduling system to generate a query for execution in a database containing a history of orders to find previous orders having similar characteristics; and
the transportation and scheduling system adapted to receive an estimated transit time for the order as a function of the previous orders having similar characteristics.

18. The system of claim 17 wherein query is generated to find previous orders having similar characteristics by matching patterns of characteristics via execution in an in memory database, wherein the similar characteristics comprise material, quantity, and supplier.

19. The system of claim 18 wherein finding previous orders having similar characteristics includes using a threshold for quantity and determining that a quantity in a found pattern is similar if it is within the threshold.

20. The system of claim 19 wherein the transportation and scheduling system is further programmed to:
provide information corresponding to the similar previous orders to a user;
receive a change to the received order; and
repeat the receiving, analyzing, and executing elements on the changed order.
